(19) United States
(12) Patent Application Publication
(10) Pub. No.: US 2004/0232190 A1
(43) Pub. Date: Nov. 25, 2004

(54) Simple adhesive tape cutter and marker

(76) Inventors: Yu-Gang Chen, Tainan County (TW); Cheng-He Tsai, Tainan County (TW); Chia-Fu Kung, Sinshin Township (TW)

Correspondence Address: Far East College, P.O. Box No. 6-57, Junghe, Taipei, 235, TW

(21) Appl. No.: 10/829,247

(22) Filed: Apr. 22, 2004

(30) Foreign Application Priority Data
May 7, 2003 (TW) 092208275

(51) Int. Cl. B26F 3/02; B65H 35/10

(52) U.S. Cl. 225/61

(57) ABSTRACT

A simple adhesive tape cutter and marker of the present invention implements the marker on an adhesive tape roll, and is primarily configured to comprise the marker affixed to a side edge of a reel of the adhesive tape roll. Length of the marker is such to enable encircling any position around a largest periphery of the adhesive tape, and a cutting member is configured on the marker. The cutting portion of the marker is employed to cut the adhesive tape; moreover the marker can be placed below a cutting position of the adhesive tape, the adhesive tape covering the marker thereat. Thus, next time the adhesive tape is to be cut, the marker directly indicates a draw-end of the adhesive tape, and thereby realizes easy lifting up of the draw-end.

### BACKGROUND OF THE INVENTION

(a) Field of the Invention

The present invention relates to a simple adhesive tape cutter and marker, whereby the cutter and marker are configured on a side edge of a reel of the adhesive tape, and the marker is configured with a cutting portion, which realizes prompt cutting of the adhesive tape. Moreover, after cutting of the adhesive tape, a draw-end of the adhesive tape is marked thereof, which thereby provides for convenient locating of the draw-end of the adhesive tape when next used.

(b) Description of the Prior Art

Primary annoyances of present adhesive tape rolls is how to speedily cut the adhesive tape, and after cutting of the adhesive tape, how to quickly locate a draw-end end of the adhesive tape ready for next usage, which can thereby minimize length of time spent locating the draw-end, and, moreover, facilitate lifting up of the draw-end. Accordingly, in order to resolve the aforementioned annoyances, a cutter is usually installed for usage when cutting the adhesive tape, and which can provide swift cutting of the adhesive tape. However, because physical measurement of the cutter is relatively large and difficult to tote around, moreover, the cutting device takes up space, therefore, a simplified cutting device has been developed, for instance, Taiwan patent No. 405598 discloses a configuration comprising a reverse U-shaped frame member, and corresponding tabling edges are configured on two sides of an inner edge at a bottom portion of the frame member, whereby the tabling edges enable catching hold within an inner core of the adhesive tape roll, thereby forming an appendage-type configuration. Furthermore, a slot is defined in a rear surface of the frame member, and breadth of the slot exactly coincides with a top edge of the adhesive tape. In addition, an adhesive protrusion assuming a rhombic shape having four inclined planes is configured at a frontal position of the slot, thereby providing dual effectiveness of adherence and lifting up of a front edge of the adhesive tape. Moreover, serrated teeth are transversally configured on an extremity of a frontal edge of the frame member in order to achieve greater labor-saving effectiveness and fast cutting of the adhesive tape. Though structure of the cutting device realizes facilitation in usage, however, breadth measurement of the cutting device is fixed, and thus the cutting device cannot be employed where varied breadths of the adhesive tape roll are to be cut, thus requiring manufacture of cutting devices to accommodate varied breadths of the adhesive tape rolls, and only then can the adhesive tape rolls of different widths be cut by the cutting devices. Hence, manufacture of the additional cutting devices increases production costs, and thus such cutting devices do not achieve practicability.

### SUMMARY OF THE INVENTION

A simple adhesive tape cutter and marker of the present invention implements the marker on an adhesive tape roll, and is primarily configured to comprise the marker affixed to a side edge of a reel of the adhesive tape roll. Length of the marker is such to enable encircling any position around a largest periphery of the adhesive tape, and a cutting member is configured on the marker.

An objective of the present invention is to provide the simple adhesive tape cutter and marker that is of simple structure, light, does not take up space, is easily portable, has low manufacturing costs, and is suitable for application on adhesive tapes of varied dimensions, which thereby realizes prompt cutting of the adhesive tape. Moreover, after cutting of the adhesive tape, a draw-end of the adhesive tape is marked thereof, which thereby provides for convenient locating of the draw-end of the adhesive tape when next used.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational exploded view according to the present invention.

FIG. 2 shows an elevational assembled view according to the present invention.

FIG. 3 shows an elevational schematic view of a cutting action according to the present invention.

FIG. 4 shows an elevational schematic view of marking of a draw-end of an adhesive tape roll according to the present invention.

FIG. 5 shows an elevational schematic view of another embodiment according to the present invention.

### DETAILED DESCRIPTION OF THE PREFERRED EMBODIMENTS

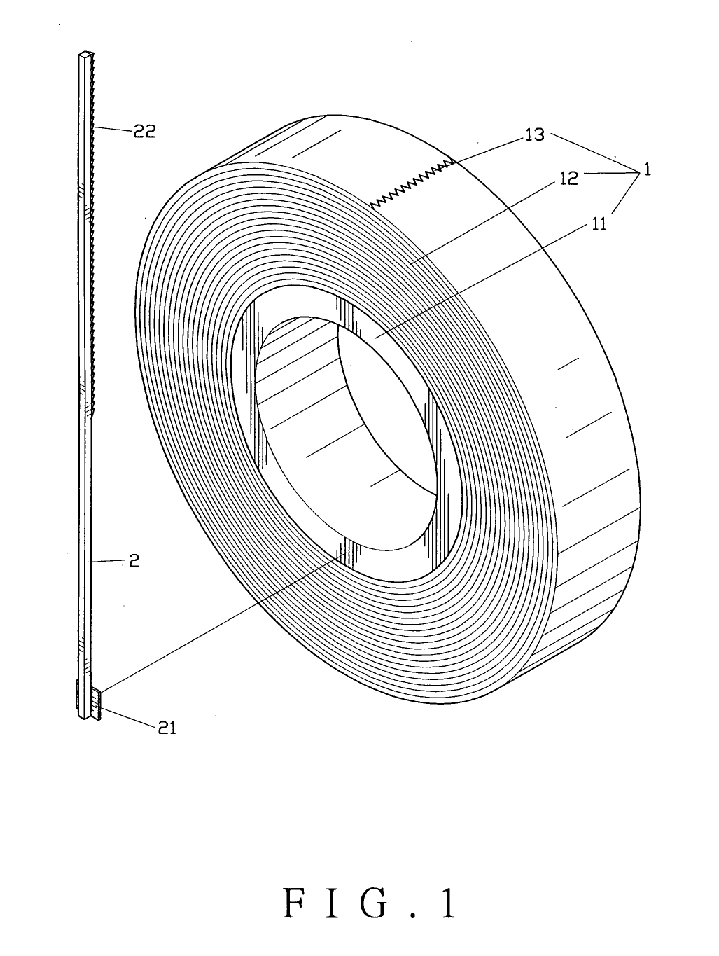

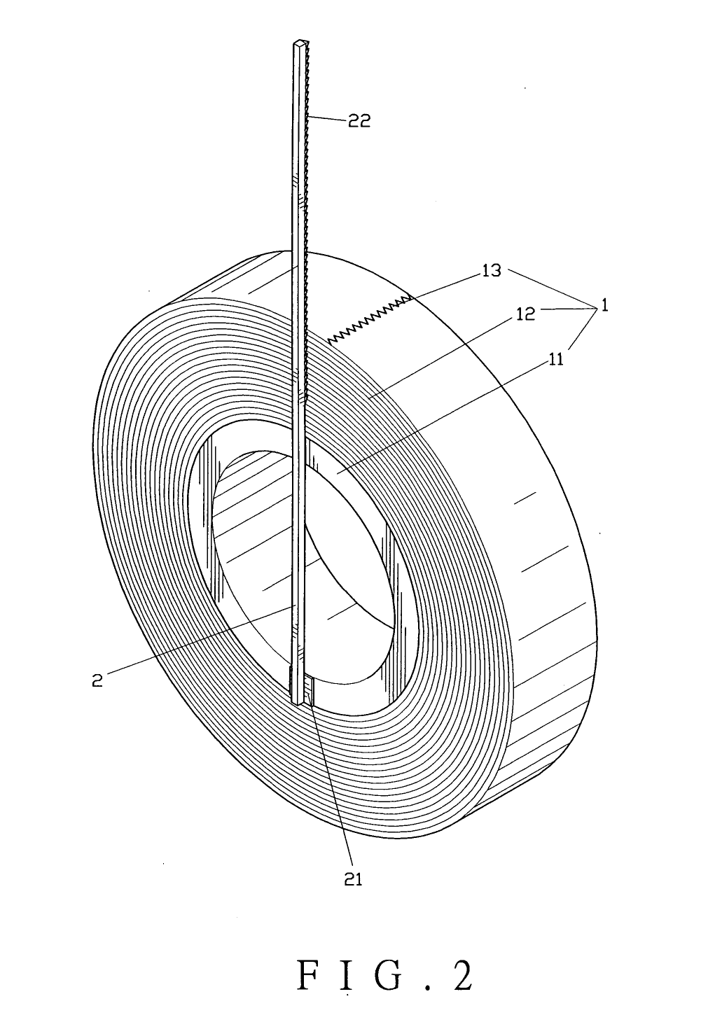

Referring to FIGS. 1 and 2, which show an embodiment of a marker (2) of the present invention being utilized in conjunction with an adhesive tape roll (1), wherein:

The adhesive tape roll (1) is provided with a hollow circular reel (11), an appropriate number of windings of adhesive tape (12) is wound onto a peripheral edge of the reel (11), and an extremity of the adhesive tape (12) forms a draw-end (3),

The marker (2) assumes a long strip form, and is affixed to a side edge of the reel (11) of the adhesive tape roll (1). The marker (2) is fabricated from a flexible material such as plastic, metal, and so on. Length of the marker (2) is such to enable encircling any position around a largest periphery of the adhesive tape (12). A fixing member (21) is configured at one end of the marker (2), and a cutting member (22) having a serrated form is further configured at another end of the marker (2).

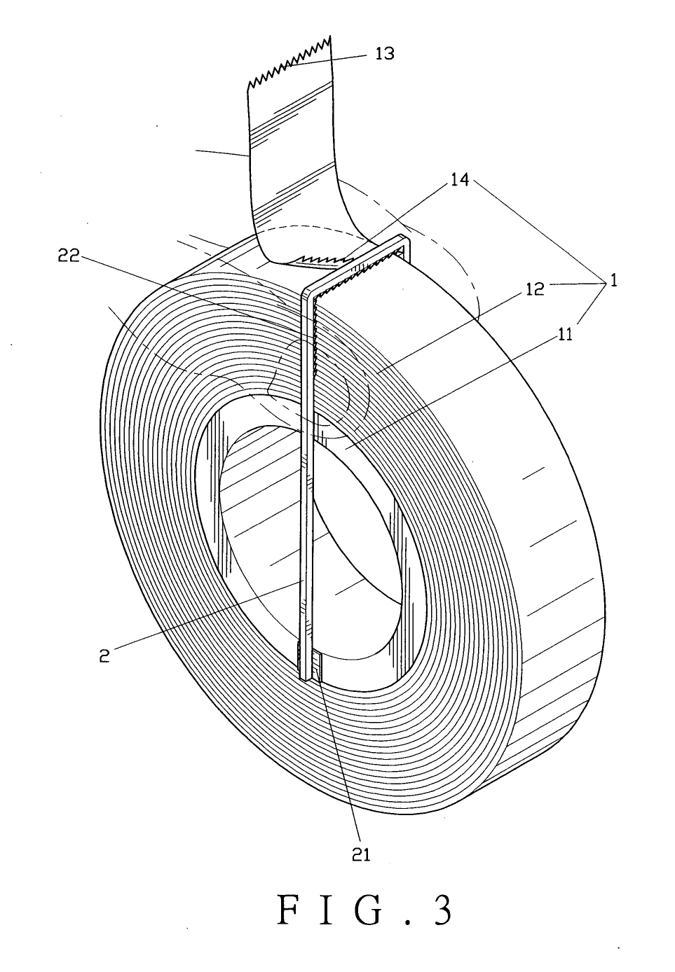

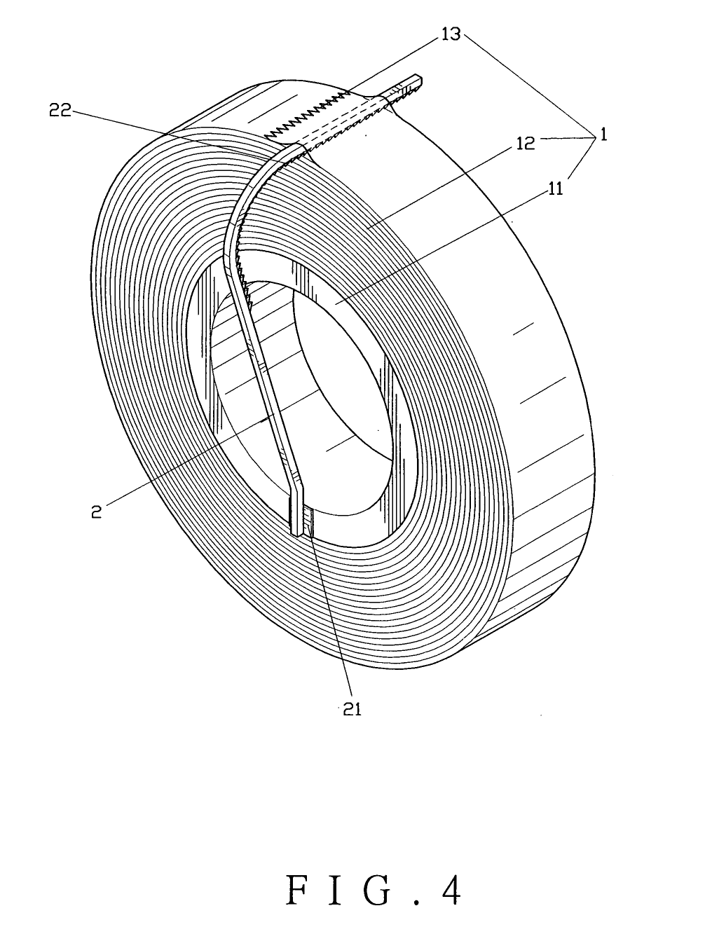

Referring to FIG. 3, when in usage, the fixing member (21) of the marker (2) is affixed to the side edge of the reel (11) of the adhesive tape roll (1), wherein jointing methods equally suitable for adoption to affix the fixing member (21) to the marker (2) include utilizing an adhesive agent, a hook and loop tape, and so on. When the adhesive tape (12) is required to be cut, the marker (2) is stretched to a position of the adhesive tape (12) where the adhesive tape (12) is to be cut, thereby readying a desired reserved length of the adhesive tape (12) for cutting. Thereafter, the cutting portion (22) of the marker (2) is transversally placed onto a desired cutting position (14) of the adhesive tape (12), and an end portion of the cutting portion (22) of the marker (2) is pressed to a side edging of the reel (11), thereby the marker (2) is drawn tight against the side edging of the reel (11). Thereupon, the adhesive tape (12) below and being pressed down by the cutting portion (22) is upwardly lifted and thereby realizes a cutting action at the desired cutting position (14) of the adhesive tape (12), thus enabling prompt cutting of the adhesive tape (12). The reserved length of the adhesive tape (12) cut off by the cutting action can thus be separated from the adhesive tape (12) and employed for adhesive usage, and the adhesive tape (12) forms a new draw-end (13) thereat. Upon completing cutting of the adhesive tape (12), the marker (2) is stretched to the draw-end (13) of the adhesive tape (12), whereupon the marker (2) to be transversally placed underneath the draw-end (13), and the draw-end (13) is stuck down atop the marker (2) thereafter, thereby covering same thereof (see FIG. 4). Hence, when next using the adhesive tape (12), an indicative functionality of the marker (2) is realized, thereby speedily and conveniently locating position of the draw-end (13) of the adhesive tape (12). Furthermore, upwardly pulling on the cutting portion (22) of the marker (2) thereby enables easy lifting up of the draw-end (13) of the adhesive tape (12), which facilitates usage thereof.

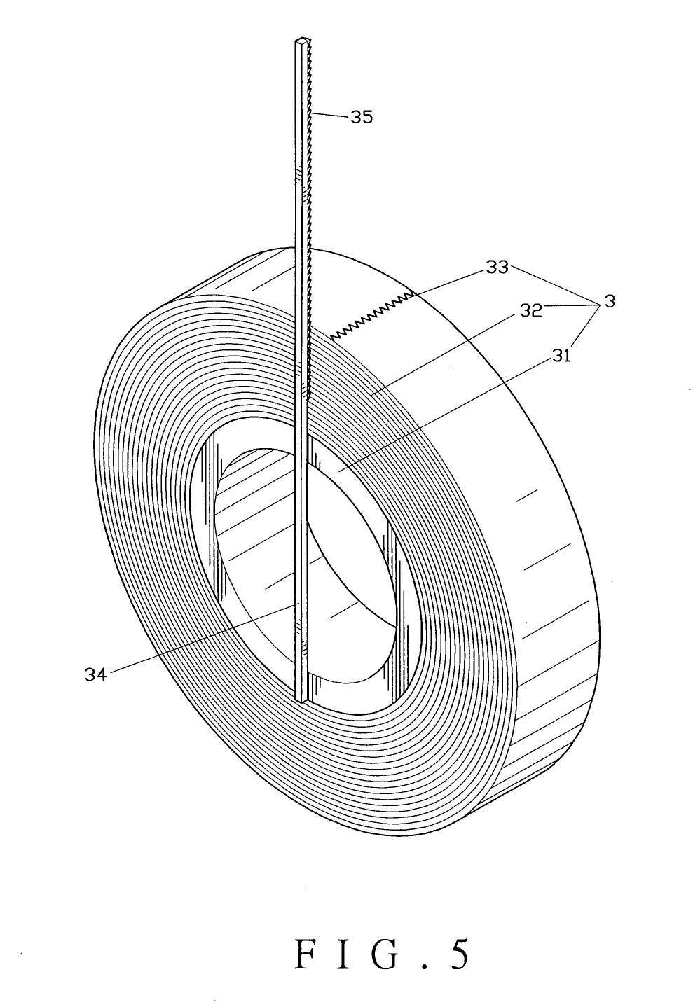

Referring to FIG. 5, which shows another embodiment of the present invention primarily configured with the adhesive tape roll (3), and the circular hollow reel (31) is configured in a center of the adhesive tape roll (3). The adhesive tape (32) is wound round a periphery of the reel (31), and an end piece of the adhesive tape (32) forms the draw-end (33). Wherein the marker (34) is configured and integrally molded with the side edge of the reel (31) of the adhesive tape roll (3). The marker (34) is fabricated from flexible material such as plastic, metal, and so on. Moreover, length of the marker (34) is such to enable the marker (34) to wrap over and encircle any position around the largest periphery of the adhesive tape (32). Thus, the embodiment enables similar functionality of speed and convenience in cutting of the adhesive tape (32) and marking of the draw-end (33) of the adhesive tape (32).

According to the aforementioned description, the present invention provides the following advantages:

1. Prompt cutting of the adhesive tape, moreover, realizes marking of the draw end of the adhesive tape, thereby providing speedy location of the draw-end and easy lifting up of same when next being used, thus saving time and facilitating usage.

2. Configuration is simple, light, does not take up space, and, moreover, is easily portable, has low manufacturing costs, and is suitable for application on adhesive tapes of varied dimensions.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A simple adhesive tape cutter and marker comprising a marker configured on an adhesive tape roll, wherein the adhesive tape roll is provided with a reel, and an appropriate number of windings of adhesive tape is wound onto a peripheral edge of the reel; the marker is flexible, and is affixed to a side edge of the aforementioned reel of the adhesive tape roll; length of the marker is such to enable encircling any position around a largest periphery of the adhesive tape, and a cutting member is configured on the marker.

2. The simple adhesive tape cutter and marker according to claim 1, wherein the cutting member of the marker is configured so as to form a serrated edge.

3. The simple adhesive tape cutter and marker according to claim 1, wherein a fixing member is configured at one end of the marker, and which provides for affixing to the reel of the adhesive tape roll thereof.

4. The simple adhesive tape cutter and marker according to claim 1, wherein the marker is configured and integrally molded with the reel of the adhesive tape roll.
